(19) United States
(12) Patent Application Publication
(10) Pub. No.: US 2015/0134296 A1
(43) Pub. Date: May 14, 2015

(54) METHOD FOR DETERMINING FUNCTIONAL VOLUMES FOR DETERMINING BIOKINETICS

(71) Applicant: COMMISSARIAT A L'ENERGIE ATOMIQUE ET AUX ENERGIES ALTERNATIVES, PARIS (FR)

(72) Inventors: Eric Barat, Limours (FR); Claude Comtat, Anthony (FR); Thomas Dautremer, Palaiseau (FR); Thierry Montagu, Montrouge (FR); Regine Trebossen, Paris (FR)

(21) Appl. No.: 14/407,250

(22) PCT Filed: Jun. 4, 2013
(86) PCT No.: PCT/EP2013/061512

§ 371 Date: Dec. 11, 2014

(30) Foreign Application Priority Data
Jun. 11, 2012 (FR) 1255459

(51) Int. Cl. G01T 1/29; G01T 1/167

(52) U.S. Cl. CPC G01T 1/2985; G01T 1/167
USPC 702/156

(57) ABSTRACT

A method for determining functional volumes for the search for kinetics representing the trend of concentration of a radioactive tracer in an area of biological tissue, being applied to spatial components comprises the following steps applied iteratively according to a Markov chain Monte-Carlo scheme: generation of a set K₀^{λ} made up of a set of candidate kinetics associated with values of probability of appearance, depending on the concentration λ of radioactive tracer; a labeling step during which, for each spatial component of index K, the probabilities of selection of the kinetics of the set K₀^{λ} are weighted by introducing a function λₖ representative of the concentration of radioactive tracer in this component to obtain a set of indicative values, an indicative value Dₖ designating the kinetic with which the spatial component K is associated; construction of functional volumes, a functional volume VFⱼ made up of the set of spatial components which share the same indicative value Dₖ.

The invention relates to a method for determining functional volumes for positron emission tomography and applies notably to the fields of positron emission tomography and pharmacokinetics.

Positron emission tomography, usually referred to by the acronym PET, is a nuclear medicine imaging technology which uses molecules marked with a positron emitting radionucleide to image, in vivo, the molecular interactions of biological processes with a minimum of perturbations. PET is the modality of reference for molecular imaging because of its molecular sensitivity of the order of the femto-mole and of the quantitative character of the measurements that it makes possible. PET imaging is used in particular to determine the functional volumes hereinafter in the description designated by the acronym VF. A functional volume VF corresponds to an area consisting of tissues exhibiting identical metabolic properties.

The state of the art in the field of estimating functional volumes proceeds indirectly by reconstructing, in a first step, a temporal series of discretized images then by estimating the functional volumes from this series of images. Now, reducing the dose of radioactive tracer, also called radiopharmaceutical, contributes to degrading the signal-to-noise ratio of each of the images to the detriment, in this indirect approach, of the determination of the functional volumes.

PET is also often used in clinical procedures in a static, 2D or 3D spatial context, in which the time variable is disregarded, for want of tools allowing for an analysis of the dynamic data that is robust, automatic and validated. This use is significantly sub-optimal. In effect, PET molecular imaging is by nature dynamic inasmuch as the distribution of the radioactive tracer injected into the organism evolves over time as a function of the molecular interactions between the tracer and the tissues. The objective of the interpretation of the examination can then be summarized as a quantitative and objective characterization of the spatial extensions exhibiting similar temporal pharmacokinetic behaviors, hence the notion of functional volumes. It is quantitative inasmuch as it has to be pronounced on the uncertainty associated with the molecular concentration contained in each functional volume in terms of quantity of radioactive tracer. It is objective inasmuch as the number, the positioning and the extension of the functional volumes do not rely on the supervision of an expert having first defined one or more regions of interest.

The state of the art in the dynamic study of biokinetics by PET imaging is based on a temporal segmentation of the information in order to obtain a 3D series. This means that the acquisition is subdivided into time slices reconstructed independently of one another. Although it allows for a dynamic tracking of the distribution of the radioactive tracer from the series of reconstructed images, this approach presents the drawback that only a proportion of the observations is used to reconstruct an image. This statistical loss fatally induces a deterioration of the quality of the reconstruction which is all the greater when the time slice is short.

Most of the time, the determination of the spatial extension of the functional volume is defined a priori, from the anatomical imaging. Then, from the temporal series of images, the concentration of mean activity inside the functional volume, which in reality corresponds to an anatomical volume, is measured, and measured for each time slice. Existing methods make it possible to determine the extension of the functional volume directly from the dynamic images. Source separating techniques are also used to determine the distinct molecular processes from the reconstructed images. However, the number of kinetics is fixed in these approaches.

A. Reader et al. take up this principle in their paper entitled Joint estimation of dynamic PET images and temporal basis functions using fully 4D ML-EM, Physics in Medicine and Biology, 51(21):5455-5474, 2006, by using a dictionary of temporal functions to seek the breakdown in a functional base which best adjusts the dataset. From a limited number of temporal basis functions, typically about ten or so, it is possible a priori to describe, by their combination, an infinite number of time activity curves, usually referred to by the acronym TAC. These 4D reconstruction methods make it possible to enhance the signal-to-noise ratio of the reconstructed images. All these techniques seek to perform a classification, also referred to by the term “clustering”, of space-time data of the disintegrations, but proceed indirectly to this end since a step of reconstructions of voxelized images over the entire space is necessary. In effect, these techniques require the discretization of all the spatial and temporal dimensions, resulting in the manipulation and storage of large volumes of data and considerable computation times. Also, the latter approach does not make it possible to quantify the estimation error without approximation.

Works on reconstruction in emission tomography without recourse to the discretization of the space have been conducted in a non-parametric Bayesian framework. This approach has been extended to the space-time reconstruction as presented in the paper by D. Fall, E. Barat, C. Comtat, T. Dautremer, T. Montagu, and S. Stute entitled Continuous space-time reconstruction in 4D PET, IEEE Medical Imaging Conference, 2011. This paper is called Fall, Barat et al. hereinafter in the description. This method addresses the problem of the quantitative determination of the reconstruction error of the functional volumes and the objective of reducing the dose injected into the patient. It further proposes a space-time “clustering” in a continuous space directly from the observations. However, in this approach, the TACs are all considered as normalized kinetics. This modeling, although it allows for the automatic detection of any number of kinetics, is not optimal inasmuch as the discrimination between kinetics uses only their forms and does not take into account the concept of concentration, that is to say the amplitude of the TACs expressed in terms of Becquerel per second, this unit being denoted Bq.s⁻¹. The limitation of this modeling comes from the model retained for the clustering of the spatial components with a particular kinetic. In effect, the latter implements a hierarchical model in which the random distribution of the kinetics, represented by K₀, is itself distributed according to a Pólya tree Dirichlet process. Then, the distribution of the space-time components denoted H is chosen as a Dirichlet process whose central measurement involves K₀. No information concerning the concentration is present in this stochastic model.

One aim of the invention is notably to mitigate the abovementioned drawbacks.

To this end, the subject of the invention is a method for determining functional volumes for the search for kinetics representing the trend of the concentration of a radioactive tracer in an area of biological tissue. The method is applied to spatial components and comprises the following steps applied iteratively according to a Markov chain Monte-Carlo scheme:
a step of generation of a set K₀^{λ} made up of a set of candidate kinetics associated with values of probability of appearance of these kinetics, these values depending on the concentration λ of radioactive tracer;
a labeling step during which, for each spatial component of index K, the probabilities of selection of the kinetics of the set K₀^{λ} are weighted by introducing therein a function λₖ representative of the concentration of radioactive tracer in this component so as to obtain a set of indicative values, an indicative value Dₖ designating the kinetic with which the spatial component K is associated;
a step of construction of functional volumes, a functional volume VFⱼ being made up of the set of the spatial components which share the same indicative value Dₖ.

According to one aspect of the invention, a step computes averages of the functional volumes VFⱼ obtained during the iterative process.

In one embodiment, a step determines statistical estimators concerning the functional volumes VFⱼ obtained during the iterative process so as to quantify the estimation uncertainty. The variance of the functional volumes VFⱼ obtained during the iterative process can then be determined. A credible interval can also be determined.

By way of example, the set K₀^{λ} is obtained by the determination of two sets of scalar variables Vⱼ and Γⱼ, these variables relating to kinetic components of index j, in which Vⱼ represents a fixed weighting coefficient independent of the concentration λ and Γⱼ represents a reference concentration value associated with the kinetic of index j.

According to one aspect of the invention, Vⱼ is determined by using the expression:

$${V}_{j} \vert D , T {\sim}^{ind} Beta ( 1 + {m}_{j} , v + \text{?} {m}_{l} \\ \text{?} \text{indicates text missing or illegible when filed}$$

an expression in which:
for any j, mⱼ designates the number of components of the distribution H allocated to the j^{th} component of K₀^{Λ}, H being a random measurement distributed according to a partially dependent Dirichlet process, K₀^{Λ} being an innumerable collection of random probability measurements which accepts, as distribution, a local Dirichlet process;
Jₖ_{ₙ} designates the greatest index of the components of K₀^{Λ} having at least one component of H allocated;
Beta(,) represents the beta probability law.

In one embodiment, Γⱼ is determined by using the expression:

$${Γ}_{j} \vert {V}_{j} , D , w , \tilde{Z} {\sim}^{ind} {U}_{j}^{*} ( {Γ}_{j} )$$

$$with$$

$${U}_{j}^{★} ( {Γ}_{j} ) ∝ ( {a}_{j , Γ}^{′} < {Γ}_{j} < {b}_{j , Γ}^{′} ) \times {\prod }_{k ∈ {𝒟}_{j}^{+}}^{ } ( 1 - {V}_{j} ( d ( {λ}_{k} , {Γ}_{j} ) < ψ ) )$$

expressions in which:
Γⱼ designates the parameter characteristic of the concentration associated with the kinetic j;
D designates the set of the variables Dₖ which indicate with which kinetic of K₀^{λ} the spatial component K is associated;
Dⱼ={k≦kₙ:Dₖ=j} represents the set of the indices K of the spatial components associated with the kinetic j;
Dⱼ⁺={k≦kₙ:Dₖ>j} represents the set of the indices K of the spatial components associated with a kinetic of index greater than j;
w designates the set of the weightings wₖ of the spatial components k in the Dirichlet mixture H;
\tilde{Z} designates the set of the parameters, average and covariance matrix,
\tilde{Z}ₖ associated with the spatial component K of the Dirichlet mixture H;
[symbol] here indicates an independent random generation for each parameter Γⱼ;
∞ here signifies “proportional to”;
[symbol] ( ) represents the “gate” function such that [symbol] (condition)=1 if condition is true, and 0 otherwise;
Vⱼ designates a coefficient associated with each kinetic involved in the weighting of said kinetic in K₀^{λ};
d( ) represents the Euclidian distance in [symbol] : d(x₁,x₂)=x₁ x₂| in which x₁, x₂∈ [symbol] ;
ψ is a threshold chosen a priori which makes it possible to parameterize K₀^{λ}.

According to one aspect of the invention, the labeling step is performed:
by independently generating for any k≦kₙ:

$$( {D}_{k} \vert V , v , {Q}^{★} , Γ , w , \tilde{Z} , C , T ) {\sim}^{ind} {\sum }_{j = 1}^{{J}^{★}} {p}_{j , k} {δ}_{j} ( \cdot )$$

$$with$$

$${p}_{j , k} ∝ ( {p}_{j} ( {λ}_{k} ) > {υ}_{k} ) max ( {p}_{j} ( {λ}_{k} ) , \text{?} ) \text{?} {f}_{{Q}_{j}^{★}} ( {T}_{i} )$$

$$and$$

$${\sum }_{j = 1}^{{J}^{★}} {p}_{j , k} = 1$$

$$\text{?} \text{indicates text missing or illegible when filed}$$

by independently generating for any K, such that kₙ<k≦k*:

$$( {D}_{k} \vert V , v , {Q}^{★} , Γ , w , \tilde{Z} ) {\sim}^{ind} {\sum }_{j = 1}^{{J}^{★}} {p}_{j , k} {δ}_{j} ( \cdot )$$

$$with$$

$${p}_{j , k} ∝ ( {p}_{j} ( {λ}_{k} ) > {υ}_{k} ) max ( {p}_{j} ( {λ}_{k} ) , \text{?} )$$

$$and$$

$${\sum }_{j = 1}^{{J}^{★}} {p}_{j , k} = 1.$$

$$\text{?} \text{indicates text missing or illegible when filed}$$

in these expressions,
kₙ designates the number of spatial components with which at least one coincidence event is associated;
k* designates the total number of spatial components of the Dirichlet mixture H for a given iteration;
V designates the set of the coefficients Vⱼ involved in the weightings of the kinetics mixture K₀^{λ};
v represents the set of the auxiliary variables vₖ, used in the representation of the Dirichlet kinetics process;
Q* designates the set of the Pólya trees Q*ⱼ characterizing the kinetics;
Γ designates the set of the parameters Γⱼ characteristic of the concentration associated with the kinetic j;
C designates the set of the classification variables Cᵢ which associate each coincidence event i with a spatial component of the Dirichlet mixture H;
T represents the set of the times of occurrences Tᵢ of the coincidence events;
p_{j,k} designates the probability of associating the component K of the Dirichlet mixture H with the kinetic j;
pⱼ(λ) represents the weight function taken at λ associated with the probability of the kinetic j of K₀^{λ};
δⱼ( ) represents the Dirac measurement function such that δⱼ(j′)=1 if j=j′ and is 0 otherwise;
[symbol] here indicates an independent random generation for each classification variable Dₖ;
max( ) represents the “maximum of” function;
ζ designates is a threshold parameter chosen arbitrarily and involved in the implementation of the “slice sampling” algorithm of the local Dirichlet kinetics process;
{i: Cᵢ=k} designates the set of the coincidence events i which are associated with the spatial component K;
f_{Q*}_{ⱼ} represents the kinetic j, i.e. the density of the Pólya tree j of the local Dirichlet mixture of kinetics;
J* designates the total number of components of the local Dirichlet mixture of kinetics for a given iteration.

According to another aspect of the invention, the concentration λₖ is obtained by the application of a function φ_{λ} defined such that λₖ=φ_{λ}(\tilde{Z}ₖ, S) with:

$${λ}_{k} = \text{?} ( {\sum }_{m = 1}^{∞} \text{?} 𝒩 ( \text{?} \vert \text{?} ) )$$

$$with$$

$$\text{?} \sim 𝒩 ( \text{?} \vert \text{?} )$$

$$\text{?} \text{indicates text missing or illegible when filed}$$

in which:
[symbol] _{\tilde{x}}_{ₖ} designates the mathematical expectation relative to the Gaussian probability law of \tilde{x}ₖ, N(\tilde{x}ₖ|\tilde{Z}ₖ);
N( ) represents the Gaussian probability law.

Also the subject of the invention is a positron emission tomography device implementing the method described previously.

The method according to the invention offers the decisive advantage of increasing the distances between functional volumes and thereby increasing the separation quality.

Also, the method according to the invention lies in a novel approach that makes it possible to shrewdly establish the a posteriori law of the concentration of each kinetic, thus conferring on the method the possibility of providing an estimation of the uncertainty on the asymptotic metabolization parameters of a tissue.

Advantageously, the method according to the invention makes it possible to substantially reduce the dose injected into the patient for a four-dimensional PET imaging while providing functional information to a molecular scale.

A repeated use of PET imaging during therapeutic monitoring can then be envisaged without any dosimetric prejudice to the patient. A wider use in pediatrics and in translational research can also be considered.

Furthermore, a reduction of the dose of radioactive tracer injected automatically brings about a reduction of the exposure to ionizing radiations of the medical personnel involved in preparing and carrying out the examination and of the entourage of the patient.

Other features and advantages of the invention will become apparent from the following description given by way of illustration and as a nonlimiting example, in light of the attached drawings in which:

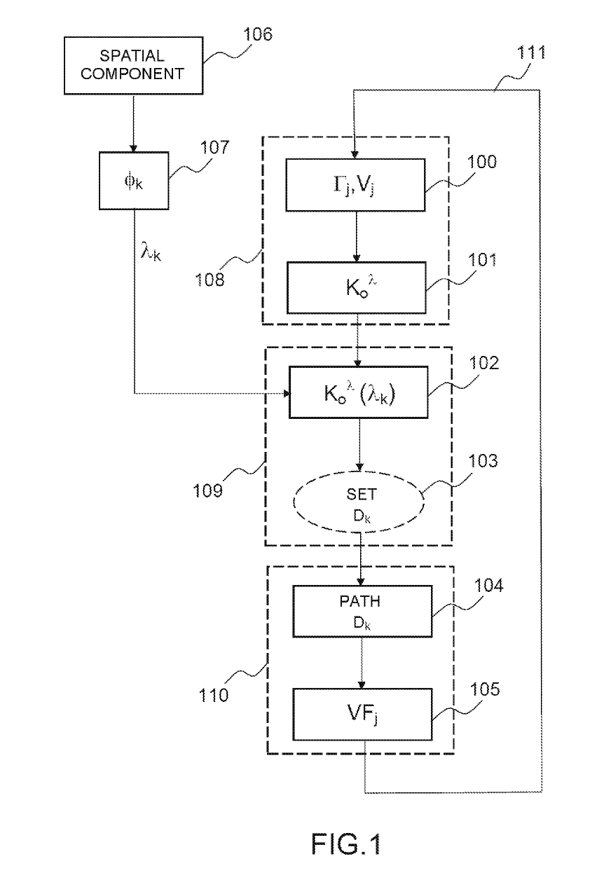

FIG. 1 schematically illustrates the various steps of the method for determining functional volumes;

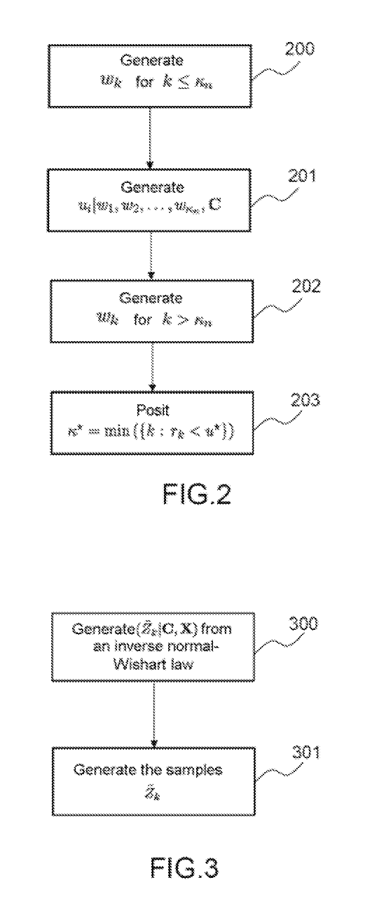

FIG. 2 illustrates how the weights and auxiliary variables of the distribution H of the space-time components are generated;

FIG. 3 schematically illustrates how the spatial parameters used by the method are generated;

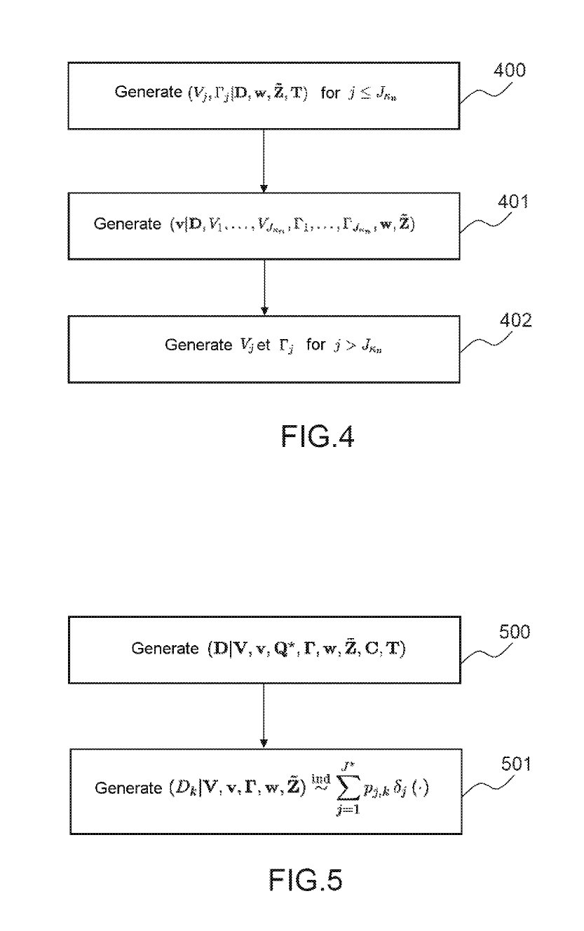

FIG. 4 schematically illustrates one way of determining the local and auxiliary variables of the set K₀^{λ};

FIG. 5 illustrates how the kinetics are allocated to the components of the set K₀^{λ};

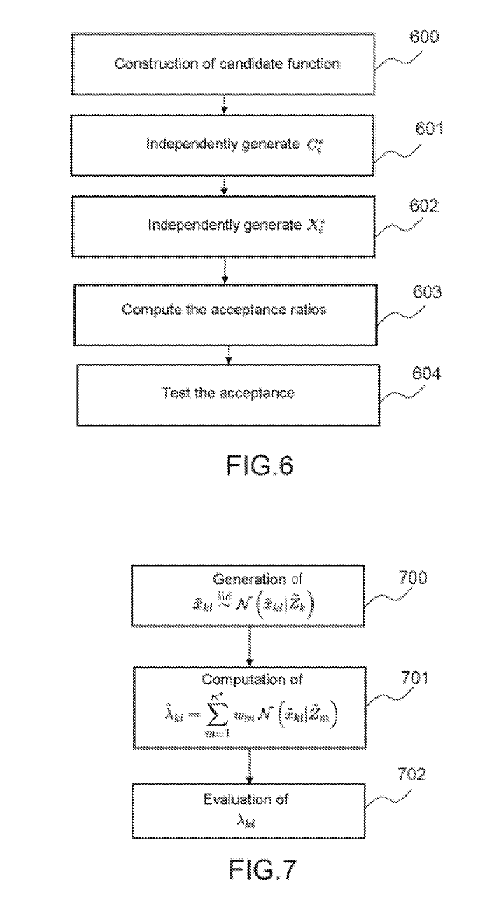

FIG. 6 shows how the places of emission are determined and how the components of H are determined;

FIG. 7 represents one way of computing the concentration λₖ of radioactive tracer;

FIG. 1 schematically illustrates the various steps of the method for determining functional volumes.

The aim of the method is to determine functional volumes for the search for kinetics. It is applied to measurements presented in the form of coincidence events 106 and comprises a series of steps applied iteratively 111 according to a Markov chain Monte-Carlo scheme.

In a first step 108, a set K₀^{λ} is generated made up of a set of candidate kinetics associated with values of probability of appearance of these kinetics, these values depending on the concentration λ of radioactive tracer.

In a so-called labeling second step 109, for each spatial component of index k 106, the probabilities of selection of the kinetics of the set Kₒ_{λ} are weighted 102 by introducing therein a function λₖ. This function is representative of the concentration of radioactive tracer of this component so as to obtain a set of indicative values 103. An indicative value Dₖ designating the kinetic with which the spatial component k is associated is determined.

In a third step 110, the functional volumes are constructed, a functional volume VFⱼ, being made up of the set of the spatial components which share the same indicative value Dₖ.

The method for determining functional volumes described hereinbelow makes it possible to mitigate the independence of the model used by Fall, Barat et al. with regard to the concentration information. To achieve this, the concentration of radioactive tracer is estimated at any point of space by marginalization, that is to say by integration over time of the distribution of space-time activity. This estimated concentration is then considered as a random co-variable endogenous to the problem. The term endogenous underscores the fact that this co-variable is not external because the latter is determined by beginning the reconstruction. Provided with this co-variable denoted λ, the proposed method implements a modeling in the distribution of the kinetics dependent on the concentration of radioactive tracer. This amounts to replacing the distribution K₀ with a collection of distributions K₀^{Λ}={K₀^{λ}: λ∈Λ}. This collection of distributions then accepts an independent Dirichlet process as distribution.

In one embodiment, a local Pólya tree Dirichlet process IDP is chosen. One consequence is that the distribution H of the space-time components is no longer generated according to a Dirichlet process but according to a distribution referred to hereinbelow in the description as partially dependent Dirichlet process and designated by the acronym pdDP.

According to one aspect of the invention, the construction of the pdDP is parameterized by a function φ_{λ} which makes it possible to link the concentration co-variable λ to the parameters of the marginal spatial distribution obtained by integration over time of the space-time distribution.

The general problem of reconstruction of a probability distribution G(·) for which only samples of a projection thereof denoted F(·) can be observed is formulated in the non-parametric Bayesian framework for the inverse problems by using the following expressions:

G˜

[symbol]

F(·, t)=∫ₓP(·|x)G(dx, t)

Yᵢ, Tᵢ|F [symbol] F, for i=1, . . . , n (1)

in which:
n is the number of samples observed;
G(·) is a random probability distribution distributed according to [symbol] , defined over (X×T, σ(X) [symbol] σ(T));
the distribution G(·) is estimated from observations distributed according to F(·): (Y, T)′={(Y₁, T₁), . . . , (Yₙ, Tₙ)};
P(·|x) is the assumed known probability distribution, called projector, indexed by x and defined over (y, σ(y));
the notation σ(ε) corresponds to the sigma-algebra over ε.

The object that is intended to be reconstructed is the spatial distribution of activity in the field of view of the tomography. In PET, each coincidence event is assigned to a virtual line LOR, LOR being an acronym for “line-of-response”, joining the centers of the two detectors. A response line LOR of index l is characterized by the parameters defining its position in the space of the detectors. A correlation is constructed below between the parameters of the LORs and the index l such that the variable yᵢ corresponds to the index of the LOR having recorded the i^{th} observed coincidence. More specifically, the observation yᵢ designates the coordinates of the LOR which joins the two detectors having recorded the coinciding photons deriving from the annihilation of the positrons having taken place at xᵢ.

In this context, the terms of the equation (1) correspond to the following interpretation:
X⊂ [symbol] ³ corresponds to the region of the reconstruction space;
T( [symbol] ⁺ corresponds to the acquisition time band;
Yᵢ corresponds to the index of the observed LOR;
Tᵢ corresponds to the time of occurrence of the i^{th} event observed;
P(y=m|x) for m=1, . . . , M is the distribution corresponding to the projector, that is to say to the probability of recording an event on the m^{th} detection LOR for a localized emission at x, that is to say the place of annihilation for any x∈X,

$${\sum }_{m = 1}^{M} 𝒫 ( y = m \vert x ) = {\int }_{y}^{ } 𝒫 ( d y \vert x ) = 1$$

G(·) is the space-time distribution of the emissions corresponding to the recorded events. The set of observations is truncated because of the limited axial field of the imager.

In order to take account of these truncations in the reconstruction, an LOR of zero index is defined, the latter corresponding to the non-observable emissions such that y*=y∪{0}. It is then possible to define the probability of projection P*(y−m|x) over (y*, σ(y*)) and

$$𝒫 ( y \vert x ) = \frac{{𝒫}^{*} ( y \vert x )}{{\int }_{y}^{ } {𝒫}^{*} ( d y \vert x )} = \frac{{𝒫}^{*} ( y \vert x )}{{\sum }_{m = 1}^{M} {𝒫}^{*} ( y - m \vert x )}$$

The space-time density of the places of emissions can then be written:

$${G}^{★} ( x , t ) ∝ \frac{G ( x , t )}{{\int }_{y}^{ } {𝒫}^{*} ( d y \vert x )}$$

an expression in which ∫_{y}P*(dy|x) designates the probability of recording a localized emission at x by taking into account the geometry of the system and the physical properties of the detection system.

The expression (2) formally defines the proposed model which makes it possible to take into account the spatial concentration as endogenous co-variable of the reconstruction problem:

Yᵢ|Xᵢ [symbol] P(Yᵢ|Xᵢ)

Xᵢ, Tᵢ|Zᵢ, Qᵢ [symbol] N(Xᵢ|Zᵢ)×Qᵢ(Tᵢ)

Zᵢ, Qᵢ|H [symbol] H

H˜pdDP(θ, G₀, K₀⁻, φₓ)

K₀^{Λ}={K₀^{λ}: λ∈Λ}˜IDP(v, PT_{L}(A, Q₀), γ₀, ψ) (2)

In this expression,
H is a random measurement distributed according to a partially dependent Dirichlet process pdDP defined as

$$H ( \cdot ) = {\sum }_{k = 1}^{∞} {w}_{k} \text{?} \text{?} ( \cdot ) \\ \text{?} \text{indicates text missing or illegible when filed} \qquad ( 3 )$$

δ_{ξ}(·) the Dirac measurement at ξ.

N(m, Σ) designates multi-variate normal-Gaussian law in dimension p=3 parameterized by its mean m and its covariance matrix Σ, of density:

$${f}_{𝒩} ( x ) = \frac{1}{( 2 π ) \text{?} {\vert \sum \vert}^{\frac{1}{2}}} exp ( - \frac{1}{2} {( x - m )}^{T} {\sum }_{ }^{- 1} ( x - m ) )$$

$$\text{?} \text{indicates text missing or illegible when filed}$$

The generative model defined in the expression (2) and the concept of pdDP of the expression (3) are explained hereinbelow.

The expression of H in (3) is a statistical mixture in which wₖ corresponds to the weight of the K^{th} component, \tilde{Z}ₖ to the spatial parameters and \tilde{Q}ₖ to the kinetic, that is to say the temporal probability distribution, of the K^{th} space-time component of the mixture. The distributions for the wₖ and \tilde{Z}ₖ are identical to those of a Dirichlet process.

w=w₁, w₂, . . . ˜GEM(θ) applies, as indicated in the paper by J. Pitman entitled “Some developments of the Blackwell-MacQueen urn scheme”, T. F. et al., editor, Statistics Probability and Game Theory, Papers in honor of David Blackwell, volume 30 of Lecture Notes-Monograph Series, pages 245-267, Institute of Mathematical Statistics, 1996, such that:
w₁=v₁;
for any k≧2, wₖ=vₖ·Πᵢ₋₁^{k-1}(1 vᵢ) in which v₁, v₂, . . . are identically distributed according to a law Beta (1, θ), of which the can be obtained by using the following expression:

$${f}_{Beta} ( υ \vert a , b ) = \frac{Γ ( a + b )}{Γ ( a ) Γ ( a )} {{υ}^{a - 1} ( 1 - υ )}^{b - 1}$$

in which the symbol Γ represents the gamma function.

\tilde{Z}=\tilde{Z}₁, \tilde{Z}₂, . . . are identically distributed according to the a priori law G₀ which can be, for example, chosen as an inverse normal-Wishart model (NIW_{ρ, n}_{₀}_{,μ}_{₀}_{,Σ}_{₀}) such that \tilde{Z}ₖ=(mₖ, Σₖ) with:

mₖ|Σₖ [symbol] N(mₖ|μ₀, Σₖ/ρ)

Σₖ¹ [symbol] W(Σₖ¹|n₀,(n₀Σ₀)¹).

in which W designates the Wishart distribution for which the density is expressed by using the expression:

$${f}_{𝒲} ( {\sum }_{ }^{- 1} ) = \frac{\vert {n}_{0} {\sum }_{0 } \vert \text{?}}{\text{?} \vert {\sum }_{ } \vert \text{?}} exp ( - \frac{{n}_{0}}{2} Tr ( {{\sum }_{ }^{- 1}}_{ } {\sum }_{0 } ) ) \\ \text{?} \text{indicates text missing or illegible when filed} \qquad ( 4 )$$

in which n₀ is the degree of freedom of the Wishart law and Σ₀ the associated scale matrix.

This is where the spatial concentration becomes involved as endogenous co-variable for the distribution of the kinetic parameters \tilde{Q}ₖ. First of all, the spatial distribution S(·) is introduced as marginal law of the space-time distribution H. The expression of S(·) is given by:

$$S ( \cdot ) = {\int }_{ℳ ( 𝒯 )}^{ } H ( \cdot , d 𝒬 ) = {\sum }_{k = 1}^{∞} {w}_{k} \text{?} ( \cdot )$$

$$\text{?} \text{indicates text missing or illegible when filed}$$

in which M(T) represents the set of the measurements over T.

It can be noted that, by the definitions of wₖ and \tilde{Z}ₖ, S(·) is distributed according to a Dirichlet process of concentration parameter 0 and a basis measurement G₀:

S˜DP(θ, G₀)

\tilde{Q}=\tilde{Q}₁, \tilde{Q}₂. . . are then independently distributed according to:

\tilde{Q}ₖ|\tilde{Z}ₖ, S [symbol] K₀^{λ}^{ₖ}

with λₖ=φ_{λ}(\tilde{Z}ₖ, S) in which φ_{λ}(·) takes its values from Λ⊂ [symbol] . For example, the function φ_{λ} can be chosen as being the value of the expectation of the spatial density taken over the component K:

$${λ}_{k} = \text{?} ( \text{?} {w}_{m} 𝒩 ( \text{?} \vert \text{?} ) )$$

$$with$$

$$\text{?} \sim 𝒩 ( \text{?} \vert \text{?} )$$

$$\text{?} \text{indicates text missing or illegible when filed}$$

It can be noted that, in the case where \tilde{Q}ₖ is independent of the marginal S such that λₖ=φ*_{λ}(\tilde{Z}ₖ), we obtain:

\tilde{Q}ₖ|\tilde{Z}ₖ [symbol] K₀^{φ*}^{ₖ}^{(\tilde{Z}}^{ₖ}⁾

\tilde{Z}ₖ, \tilde{Q}ₖ [symbol] F₀

expressions in which F₀(\tilde{Z}ₖ, \tilde{Q}ₖ)=G₀(\tilde{Z}ₖ)K₀^{φ*}^{ₖ}^{(\tilde{Z}}^{ₖ}⁾(\tilde{Q}ₖ). This implies that H˜DP(θ, F₀).

The distribution of H is a Dirichlet process. In this situation the concentration is not involved as endogenous co-variable. However, the model then covers the possibility of having recourse to an exogenous co-variable originating from information of anatomical type for example.

The distribution of the K₀^{λ} remains to be established. K₀^{Λ}={K₀^{λ}: λ∈Λ} is defined as an innumerable collection of random probability measurements which accepts, as distribution, a local Dirichlet process denoted IDP, defined as follows. If:
V=V₁, V₂, . . . are identically distributed such that Vⱼ [symbol] Beta (1, v),
Q*=Q*₁, Q*₂, . . . are identically distributed such that Q*ⱼ [symbol] PT_{L(A, Q}₀) is a Pólya tree with L-levels, of parameters A and of basis distribution Q₀,
Γ=Γ₁, Γ₂, . . . are identically distributed such that Γⱼ [symbol] γ₀,
   then,

$${K}_{0}^{λ} ( \cdot ) = {\sum }_{j = 1}^{∞} {p}_{j} ( λ ) \text{?} ( \cdot )$$

$$\text{?} \text{indicates text missing or illegible when filed}$$

with p(λ)=p₁(λ),p₂(λ), . . . defined by the expression in which:

$${p}_{j} ( λ ) = {\tilde{V}}_{j} ( λ ) {\prod }_{l < j} ( 1 - {\tilde{V}}_{l} ( λ ) )$$

$$in which$$

$${\tilde{V}}_{j} ( λ ) = {V}_{j} ( d ( λ , {Γ}_{j} ) < ψ )$$

and d(λ, λ′) represents the Euclidian distance between λ and λ′.

It will be noted that if K₀^{Λ}−{K₀^{λ}: λ∈Λ}˜IDP(v, PT(A, Q₀), γ₀, ψ), then for any λ∈Λ, K₀^{λ}|λ˜DP(v, PT(A, Q₀)). The conditional law of K₀^{λ} knows that λ is a Pólya tree Dirichlet process.

It will be noted that in the limit case where ψ→∞, there is, for any λ∈Λ, K₀^{λ}=K₀ with K₀˜DP(v, PT(A, Q₀)), consequently

H˜DP(θ, G₀×K₀)

The definition of a Pólyatree to complete the model remains to be reviewed. We adopt the Lavine formulism presented in his paper entitled Some aspects of Pólya tree distributions for statistical modelling, Ann. Statist., 20:1222-1235, 1992, for the definition of the dyadic Pólya tree. Take E={0, 1} and the E^{l} the l-cartesian product E× . . . ×E with E⁰=. Let E*=∪ₗ₌₀^{∞}E^{l}. Let B={T} and let Π={B₀, B₁, B₀₀, B₀₁, . . . } and separable binary tree of partitions of T such that sets B_{∈}_{₁} _{. . . ∈l+1} are obtained by binary subdivision of the sets B_{∈}_{₁} _{. . . ∈l} and ∪ₗ₌₀^{∞}B_{∈}_{₁} _{. . . ∈l+1} defines the measurable sets. The index 0 (respectively 1) is interpreted as 0 (respectively 1).

It is said that the random measurement Q over T accepts as distribution a Pólya tree of parameters (A, Q₀) that will be noted Q˜PT(A, Q₀), if there are positive real values A={α_{∈}: ∈∈E*} and random variables W={W_{∈}: ∈∈E*} such that:
the collection W consists of mutually independent random variables,
∀_{∈}∈E*, W_{∈}˜Beta (α_{∈0}, α_{∈1}),
∀l=1, 2, . . . et ∀_{∈}∈E^{l},

$$Q ( {B}_{{ε}_{1} … {ε}_{l}} ) = ( {\prod }_{{k = 1}_{\{ k : {ε}_{k} = 0 \}}}^{l} {W}_{{ε}_{1} … {ε}_{k - 1}} ) ( {\prod }_{{k = 1}_{\{ k : {ε}_{k} = 1 \}}}^{l} {W}_{{ε}_{1} … {ε}_{k - 1}} )$$

with factors equal to W in which 1−W if k−1.
Consider the probability measurement Q₀. The Pólya tree can be centered around Q₀ by taking:

$${B}_{{ε}_{1} … {ε}_{l}} = ( {Q}_{0}^{- 1} ( \frac{{\sum }_{k = 1}^{l} {ε}_{k} {2}^{k - 1}}{{2}^{l}} ) , {Q}_{0}^{- 1} ( \frac{{\sum }_{k = 1}^{l} {ε}_{k} {2}^{k - 1} + 1}{{2}^{l}} ) )$$

$$and {α}_{ε 0} = {α}_{ε 1} , ∀ ε ∈ {E}^{*}$$

In this case, we note α_{∈}=aₗ for l=1, 2, . . . and ∀_{∈}∈E^{l}. This construction scheme defines the canonical Pólya tree. In this context, if Q˜PT(A, Q₀), then [symbol] (Q)=Q₀.

The construction of the partition can be continued to infinity but, since it is not possible to consider computing an infinite tree in practice, the Pólya trees are often simplified by specifying the parameters and by constructing the partition up to a bounded level L. If we note f_{Q}(·), the density of probability of Q˜PT_{L}(A, Q₀), then:

∀t∈B_{∈}_{₁} _{. . . ∈}_{_{L}}, f_{Q}(t)=2^{L}f_{Q}_{ₙ}(t)·Q(B_{∈}_{₁} _{. . . ∈}_{_{L}})

The justification for a partial specification of the Pólya tree can be supported by the fact that, for the continuous distributions, the parameters rapidly increase as a function of the levels of the tree. The updating of the law from the data then has little a priori influence on the law because the number of observations in the high levels become small compared to the a priori parameter.

Since the objective is to culminate with an algorithm for reconstruction of the functional volumes, the method according to the invention can be provided with auxiliary variables which will render the iterative reconstruction procedure and the implementation of an MCMC-type method, MCMC standing for “Markov chain Monte-Carlo”, effective.

We introduce C=C₁, C₂, . . . , Cₙ, the data classification variables, to the components of H such that (Zᵢ, Qᵢ)=(\tilde{Z}_{C}_{ᵢ}, \tilde{Q}_{C}_{ᵢ}) for any i<n. Similarly, let D=D₁, D₂, . . . such that \tilde{Q}ₖ=Q*_{D}_{ₖ} for any K.

The auxiliary variables for the sampling by slices, usually referred to by the expression “slice sampling”, are described hereinbelow.

In order to implement an effective Gibbs sampler, we follow a so-called slice sampling technique as described in the paper by M. Kalli, J. E. Griffin and S. G. Walker entitled Slice sampling mixture models, Statistics and Computing, 21(1):93-105, 2011. This approach requires the introduction of additional variables.

Let u=u₁, u₂, . . . , uₙ be uniform random variables. The joint density of (Xᵢ, Tᵢ, uᵢ), for any positive sequence (ξₖ), can be determined by using the expression:

$$( {X}_{i} , {T}_{i} , {u}_{i} \vert w , \tilde{Z} , \tilde{Q} ) ∼ {\sum }_{k = 1}^{∞} 𝒰 ( {u}_{i} \vert 0 , {ξ}_{k} ) {w}_{k} 𝒩 ( {X}_{i} \vert {\tilde{Z}}_{k} ) {\tilde{Q}}_{k} ( {T}_{i} )$$

in which u(·|a, b) is the uniform distribution over ]a, b]. We easily check that, by marginalization on uᵢ of the preceding formula, we obtain the distribution of (Xᵢ, Tᵢ|w, \tilde{Z}, \tilde{Q}). We propose adopting a dependent slice variable (ξₖ), that is to say that, for any K, ξₖ=min (wₖ, ζ)
in which ζ∈]0, 1] and is independent of wₖ. In practice, values of ζ corresponding to the expectation of the weight of the first component that does not have any datum allocated offer satisfactory mixture properties

$$( ζ \approx \frac{0}{( n + 0 ) ( 1 + 0 )} ) .$$

Provided with this choice of ξₖ, the following expression is obtained:

$$( {X}_{i} , {T}_{i} , {u}_{i} \vert w , \tilde{Z} , \tilde{Q} ) ∼ {ζ}^{- 1} {\sum }_{{u}_{i} < ζ < {w}_{k}} {w}_{k} 𝒩 ( {X}_{i} \vert {\tilde{Z}}_{k} ) {\tilde{Q}}_{k} ( {T}_{i} ) + {\sum }_{{u}_{i} < {w}_{k} \leq ζ} 𝒩 ( {X}_{i} \vert {\tilde{Z}}_{k} ) {\tilde{Q}}_{k} ( {T}_{i} )$$

in which the two sums are finite by virtue of #{j: wⱼ>ε}<∞ for any ε>0.

Similarly, let v=v₁, v₂, . . . be uniform auxiliary variables and ζ∈]0, 1]. Then, for any K, the following applies:

$$( {\tilde{Q}}_{k} , {υ}_{k} \vert V , {Q}^{*} , Γ , w , {\tilde{Z}}_{k} , S ) ∼ {ς}^{- 1} {\sum }_{{υ}_{k} < ς < {p}_{j} ( {λ}_{k} )} {p}_{j} ( {λ}_{k} ) {δ}_{{Q}_{j}^{*}} ( {\tilde{Q}}_{k} ) + {\sum }_{{υ}_{k} < {p}_{j} ( {λ}_{k} ) \leq ς} {δ}_{{Q}_{j}^{*}} ( {\tilde{Q}}_{k} )$$

expression in which λₖ=φ_{λ}(\tilde{Z}ₖ, S) and pⱼ(λₖ) are defined above.

The model (2) is then rewritten by adding to it the hidden and auxiliary variables:

$${Y}_{i} \vert {X}_{i} {∼}^{ind} 𝒫 ( {Y}_{i} \vert {X}_{i} ) \\ {X}_{i} , {T}_{i} \vert {C}_{i} , D {∼}^{ind} 𝒩 ( {X}_{i} \vert {\tilde{Z}}_{{C}_{i}} ) \times {Q}_{{D}_{{C}_{i}}}^{*} ( {T}_{i} ) \\ {C}_{i} , {u}_{i} \vert w {∼}^{iid} {\sum }_{k = 1}^{∞} 𝒰 ( {u}_{i} \vert 0 , min ( ζ , {w}_{k} ) ) {w}_{k} {δ}_{k} ( {C}_{i} ) \\ {D}_{k} , {υ}_{k} \vert V , Γ , w , \tilde{Z} {∼}^{ind} {\sum }_{j = 1}^{∞} 𝒰 ( {υ}_{k} \vert 0 , min ( ς , {p}_{j} ( {λ}_{k} ) ) ) {p}_{j} ( {λ}_{k} ) {δ}_{j} ( {D}_{k} ) \\ w ∼ GEM ( θ ) \\ {\tilde{Z}}_{k} {∼}^{iid} {𝒩ℐ𝒲}_{ϱ , {n}_{0} , {μ}_{0} , {Σ}_{0}} \\ {V}_{j} {∼}^{iid} Beta ( 1 , ν ) \\ {Γ}_{j} {∼}^{iid} {ϒ}_{0} \\ {Q}_{j}^{*} {∼}^{iid} {PT}_{L} ( 𝒜 , {Q}_{0} ) \\ with \\ {p}_{j} ( {λ}_{k} ) = {\tilde{V}}_{j} ( {λ}_{k} ) {Π}_{l < j} ( 1 - {\tilde{V}}_{l} ( {λ}_{k} ) ) , \\ {\tilde{V}}_{j} ( {λ}_{k} ) - {V}_{j} ( d ( {λ}_{k} , {Γ}_{j} ) < ψ ) \\ and \\ {λ}_{k} = {𝔼}_{{\tilde{x}}_{k}} ( {\sum }_{l = 1}^{∞} {w}_{l} 𝒩 ( {\tilde{x}}_{k} \vert {\tilde{Z}}_{l} ) ) \qquad ( 5 )$$

From this generative model, it is possible to express the different a posteriori conditional laws which will be involved in the Gibbs sampler.

The sampling of the a posteriori conditional laws by Markov chain Monte-Carlo MCMC algorithm is described hereinbelow with the support of FIGS. 2 to 7.

From the expression (5), the MCMC sampler generates, in succession, samples originating from the following conditional distributions:
Places of emission/allocation to the components of H: (X, C|w,u,\check{Z}, Q*, D, Y, T)
Spatial parameters: (\check{Z}|C, X)
Weights and auxiliary variables of H: (w, u|C)
Allocation of the kinetics to the components of K₀^{Λ}: (D|V, v, Q*, Γ, w, \check{Z}, C, T)
Pólya trees of the kinetics: (Q*|D, C, T)

Weightings, local variables and auxiliaries of K₀^{Λ}: (V, Γ, v|D, w, \check{Z}, T)

FIG. 2 illustrates how the weights and auxiliary variables of the distribution H of the space-time components are generated, that is to say how samples of conditional distribution (w,u|C) are generated.

We denote kₙ the latent number of components of the space-time mixture for n observations and nₖ=#{i: Cᵢ=k} for k≦kₙ. We adopt the approach presented in the paper by Kalli et al., previously cited, and proceed with the joint generation of (w, u|C) by first of all sampling w₁, w₂, . . . , wₖ_{ₙ}|C, then u|w₁, w₂, . . . , wₖ_{ₙ}, C, and finally wₖ_{ₙ}₊₁, wₖ_{ₙ}₊₂, . . . |u, w₁, w₂, . . . , wₖₙ, C.

In this context, by following the new definition and the corollary twenty of the paper by J. Pitman entitled Some developments of the Blackwell-MacQueen urn scheme in T. F. et al., editor, Statistics, Probability and Game Theory; Papers in honor of David Blackwell, volume 30 of Lecture Notes—Monograph Series, pages 245-267, Institute of Mathematical Statistics, 1996, we are able to express the a posteriori law of the Dirichlet process as the sum of a finite sum of components whose weights are distributed by a Dirichlet distribution and of a data-independent Dirichlet process. The presence of the auxiliary variable u makes it possible to generate only a finite number k* of weights and of places of emission in the generation of the independent Dirichlet process.

In a first stage 200, the wₖ are generated for k≦kₙ.

(w₁, w₂, . . . , wₖ_{ₙ}, rₖ_{ₙ}|C)˜Dirichlet (n₁, n₂, . . . , nₖ_{ₙ}, θ)

In a second stage 201, the samples uᵢ|w₁, w₂, . . . , wₖ_{ₙ}, C are generated.

uᵢ|C [symbol] u(uᵢ|0, min (w_{C}_{ᵢ}, ζ))

u*=min(u)

In a third stage 202, the samples wₖ are generated for k>kₙ.
As long as rₖ₋₁>u*,

Uₖ˜Beta (1, θ)

wₖ=Uₖrₖ₋₁

rₖ=rₖ₋₁(1−Uₖ)

In a fourth stage 203, k*=min({k: rₖ<u*}) is posited.
Clearly, wₖ<u* for any k>k*. For this reason, a finite set of wₖ is sufficient for the allocation of the data to the components. It should be added that we also abandon in the computations all the wₖ such that wₖ<u* for k≦kₙ.

FIG. 3 schematically illustrates how the spatial parameters are generated, that is to say how samples of conditional distribution \tilde{Z} C, X) are generated.

In a first stage 300, (\tilde{Z}ₖ|C, X) are generated for any k≦kₙ, from an inverse normal-Wishart law whose parameters are updated from the observations, through the conjugation property:

$${m}_{k} \vert {Σ}_{k} , C , X {∼}^{ind} 𝒩 ( {μ}_{k} , \frac{{Σ}_{k}}{{ϱ}_{k}} )$$

$$with$$

$${ϱ}_{k} = ϱ + {n}_{k}$$

$${μ}_{k} = \frac{ϱ {μ}_{0} + {n}_{k} }{ϱ + {n}_{k}}$$

$$= \frac{1}{{n}_{k}} {\sum }_{\{ i : {C}_{i} = k \}} {X}_{i}$$

$$and$$

$${Σ}_{k}^{- 1} \vert C , X {∼}^{ind} 𝒲 ( {η}_{k} , {( {η}_{k} {\tilde{Σ}}_{k} )}^{- 1} )$$

$$with$$

$${η}_{k} = {n}_{0} - {n}_{k}$$

$${\tilde{Σ}}_{k} = \frac{1}{{η}_{k}} [ {n}_{0} {Σ}_{0} + {n}_{k} + \frac{( {μ}_{0} - ) {( {μ}_{0} - )}^{⊤}}{\frac{1}{ϱ} + \frac{1}{{n}_{k}}} ]$$

$$= \frac{1}{{n}_{k}} {\sum }_{\{ i : {C}_{i} = k \}} ( {X}_{i} - ) {( {X}_{i} - )}^{⊤}$$

In a second stage 301, the samples \tilde{Z}ₖ are generated:

\tilde{Z}ₖ [symbol] NIW_{ρ, n}_{₀}_{,μ}_{₀}_{,Σ}_{₀}, for kₙ<k≦k*

FIG. 4 schematically illustrates one way of determining the local and auxiliary variables of the set K₀^{λ}.

For this, (V, Γ, v|D, w, \tilde{Z}, T) must be generated.

We consider as a priori law γ₀(·)=u(·|a_{Γ}, b_{Γ}). For any j, we define

Dⱼ={k≦kₙ: Dₖ=j}

Dⱼ⁺={k≦kₙ: Dₖ>j}

and designate, for any j, mⱼ=#Dⱼ as the number of components of H allocated to the j^{th} component of K₀^{Λ}.
We also define the greatest index of the components of K₀^{Λ} having at least one component of H allocated:

Jₖ_{ₙ}=max({j: mⱼ>0})

We adopt the same generation scheme as for the sampling of (w, u|C), that is to say we first generate (Vⱼ, Γⱼ|D, w, \tilde{Z}, T) for j≦Jₖ_{ₙ} 400, then

$$( v \vert D , {V}_{1} , ⋯ , {V}_{{J}_{{κ}_{n}}} , {Γ}_{1} , ⋯ , {Γ}_{{J}_{{κ}_{n}}} , w , \tilde{Z} )$$

401 and, finally, Vⱼ and Γⱼ for j>jₖ_{ₙ} 402.
For any j≦Jₖ_{ₙ}, the following are generated independently:

$${V}_{j} \vert D , T {∼}^{ind} Beta ( 1 + {m}_{j} , ν {\sum }_{l = j + 1}^{{J}_{{κ}_{n}}} {m}_{l} )$$

For any j≦Jₖ_{ₙ}, we posit:

$${a}_{j , Γ}^{′} = max ( {max}_{k ∈ {𝒟}_{j}} ( {λ}_{k} - ψ ) , {a}_{Γ} )$$

$${b}_{j , Γ}^{′} = min ( {min}_{k ∈ {𝒟}_{j}} ( {λ}_{k} + ψ ) , {b}_{Γ} )$$

then generate:

$${Γ}_{j} \vert {V}_{j} , D , w , \tilde{Z} {∼}^{ind} {𝒰}_{j}^{*} ( {Γ}_{j} )$$

$$in which$$

$${𝒰}_{j}^{*} ( {Γ}_{j} ) ∝ ( {a}_{j , Γ}^{′} < {Γ}_{j} < {b}_{j , Γ}^{′} ) \times {\prod }_{k ∈ {𝒟}_{j}^{+}} ( 1 - {V}_{j} ( d ( {λ}_{k} , {Γ}_{j} ) < ψ ) )$$

The sampling of u*ⱼ requires a Metropolis-Hastings (MH) step. We propose an independent MH sampler with, as candidate distribution:

g(Γⱼ)=u(Γⱼ|a′_{j,Γ}, b′_{j,Γ})

Thus, on the iteration \|⊥, for any j≦Jₖₙ,
generate Γ*ⱼ [symbol] u(Γⱼ|a′_{j,Γ}, b′_{j,Γ}).
Compute the acceptance ratio w(Γ*ⱼ, Γⱼ^{(t)})

$$ω ( {Γ}_{j}^{*} \cdot {Γ}_{j}^{( t )} ) = \begin{matrix}{\prod }_{k ∈ {𝒟}_{j}^{+}} ( 1 - {V}_{j} ( d ( {λ}_{k} , {Γ}_{j}^{*} ) < ψ ) ) \\ {\prod }_{k ∈ {𝒟}_{j}^{+}} ( 1 - {V}_{j} ( d ( {λ}_{k} , {Γ}_{j}^{( t )} ) < ψ ) )\end{matrix}$$

in which Γⱼ^{(t)} is the value of the Markov chain on the iteration t.
Test the acceptance of the proposition Γ*ⱼ, i.e. assign Γⱼ^{(t+1)}=Γ*ⱼ with a probability

min(1, ω(Γ*ⱼ, Γⱼ^{(t)})),

otherwise assign Γⱼ^{(t+1)}=Γⱼ^{(t)}.
For any k≦kₙ, posit ρ_{j,k}=ρ_{j-1,k}(1−Vⱼ [symbol] (d(λₖ, Γⱼ)<ψ)) and ρ*ⱼ=min(ρ_{j,1}, . . . , ρ_{j,k}_{ₙ}).
For any k≦kₙ, independently generate

$${υ}_{k} \vert D , {V}_{1} , … , {V}_{{J}_{{κ}_{n}}} , {Γ}_{1} , … , {Γ}_{{J}_{{κ}_{n}}} , w , \tilde{Z} {∼}^{ind} 𝒰 ( {υ}_{k} \vert 0 , min ( {p}_{{D}_{k}} ( {λ}_{k} ) , ς ) )$$

and posit

v*=min(v)
Generate Vⱼ et Γⱼ for j>Jₖ_{ₙ}. As long as ρ*ⱼ₋₁>v*,

Vⱼ [symbol] Beta(1, v)

Γⱼ [symbol] u(Γⱼ|a_{Γ}, b_{Γ})
For any k≦kₙ, posit ρ_{j,k}=ρ_{j-1,k}(1−Vⱼ [symbol] (d(λₖ, Γⱼ)<ψ)) and ρ*ⱼ=min(ρ_{j,1}, . . . , ρ_{j,k}_{ₙ}).
Posit J*=min({j: ρ*ⱼ<v*}).

FIG. 5 illustrates how the kinetics are allocated to the components of K₀^{λ}, that is to say how (D|V, v, Q*, Γ, w, \tilde{Z}, T) is generated.

In a first stage 500, the following is generated independently for any k≦kₙ:

$$( {D}_{k} \vert V , v , {Q}^{*} , Γ , w , \tilde{Z} , C , T ) {∼}^{ind} {\sum }_{j = 1}^{{J}^{*}} {p}_{j , k} {δ}_{j} ( \cdot )$$

$$with$$

$${p}_{j , k} ∝ ( {p}_{j} ( {λ}_{k} ) > {υ}_{k} ) max ( {p}_{j} ( {λ}_{κ} ) , ς ) {\prod }_{\{ i : {C}_{i} = k \}} {f}_{{Q}_{j}^{*}} ( {T}_{i} ) \\$$

and Σⱼ₌₁^{J*}P_{j,k}−1.
In a second stage 501, the following is generated for any K, such that kₙ<k<k*:

$${D}_{k} \vert V , v , Γ , w , \tilde{Z} {∼}^{ind} {\sum }_{j = 1}^{{J}^{*}} {p}_{j , k} {δ}_{j} ( \cdot )$$

$$with$$

$${p}_{j , k} ∝ ( {p}_{j} ( {λ}_{k} ) > {υ}_{k} ) max ( {p}_{j} ( {λ}_{κ} ) , ς )$$

$$and {\sum }_{j = 1}^{{J}^{*}} {p}_{j , k} - 1.$$

The Pólya trees of the generated kinetics must then be generated. According to the conjugation property of the Pólya tree, for any j≦Jₖ_{ₙ}, (Q*ⱼ|D, C, T) is generated independently according to a Pólya tree distribution with updated parameters A′ⱼ−{α′_{j,τ}: ε∈E*} such that

Q*ⱼ|D, C, T [symbol] PT_{L}(A′ⱼ, Q₀)

with

α′_{j,τ}−α_{τ}+n_{j,τ}

and

n_{j,∈}=#{i∈{1, . . . , n}: (D_{C}_{ᵢ}=j)̂(Tᵢ∈B_{∈})}

Then, for any Jₖ_{ₙ}<j≦J*, independently generate

Q*ⱼ|D, C, T [symbol] PT_{L}(A, Q₀)

FIG. 6 shows how the places of emission are determined and how the components of H are determined. This is by generating (C, X|w, u, \tilde{Z}, Q*, D, Y, T).

The conditional law has a form which does not allow for a direct generation. In effect, it involves a projector P(Yᵢ|Xᵢ) which incorporates geometrical and physical characteristics of the detection device, which in practice precludes finding an analytical expression for the distribution that offers a hope of simple generation. We therefore have recourse to a Metropolis-Hastings step. We begin by expressing the conditional distribution by using the Bayes rule:

$${C}_{i} , {X}_{i} \vert {Y}_{i} , {T}_{i} , {u}_{i} , w , \tilde{Z} , {Q}^{*} , D {∼}^{ind} 𝒫 ( {Y}_{i} \vert {X}_{i} ) \times {\tilde{G}}_{i} ( {C}_{i} , {X}_{i} )$$

$$with$$

$${f}_{{\tilde{G}}_{i}} ( {C}_{i} , {X}_{i} ) ∝ {\sum }_{k = 1}^{{κ}^{*}} ( {w}_{k} > {u}_{i} ) max ( {w}_{k} , ζ ) {f}_{𝒩} ( {X}_{i} \vert {\tilde{Z}}_{k} ) {f}_{{Q}_{{D}_{k}}^{*}} ( {T}_{i} ) {δ}_{k} ( {C}_{i} )$$

and P(Yᵢ|Xᵢ) corresponds to the likelihood of the projector for the sets of observed events (truncated). Since this likelihood does not accept any standard form allowing for direct sampling, we use an independent Metropolis-Hastings algorithm and have to define a candidate law that we denote G*ᵢ for i=1, . . . , n. On each iteration t+1 we have to generate (C*ᵢ, X*ᵢ)˜G*ᵢ and compute the acceptance ratio. This step is the most costly in terms of computations.

We thus propose a candidate law of the form:

f_{G*}_{ᵢ}(C*ᵢ, X*ᵢ)∝f_{N}(X*ᵢ|m*_{Y}_{ᵢ}, Σ*_{Y}_{ᵢ})×f_{G}_{ᵢ}(C*ᵢ, X*ᵢ)

We replace the projector P(Yᵢ|Xᵢ) with N(Xᵢ|m*_{Y}_{ᵢ}, Σ*_{Y}_{ᵢ}) in the conditional law to construct the candidate distribution 600, in which m*_{Y}_{ᵢ} and Σ*_{Y}_{ᵢ} are chosen in such a way as to suitably approximate P(Yᵢ|Xᵢ). We can then express f*_{G}_{ᵢ}(·) by using the expression:

$${f}_{{G}_{i}^{*}} ( {C}_{i}^{*} , {X}_{i}^{*} ) ∝ {\sum }_{k = 1}^{{κ}^{*}} ( {w}_{k} > {u}_{i} ) max ( {w}_{k} , ζ ) {\overline{η}}_{k , {Y}_{i}} {f}_{𝒩} ( {X}_{i}^{*} \vert {\overline{m}}_{k , {Y}_{i}} , {\overline{Σ}}_{k , {Y}_{i}} ) {f}_{{Q}_{{D}_{k}}^{*}} ( {T}_{i} ) {δ}_{k} ( {C}_{i}^{*} )$$

with, for any k≦k* and m≦M,

η̅_{k,m}=f_{N}(m*ₘ|mₖ, Σ*ₘ−Σₖ)

m̅_{k,m}=((Σ*ₘ)⁻¹+Σₖ⁻¹)⁻¹((Σ*ₘ)⁻¹m*ₘ+Σₖ⁻¹mₖ)

Σ̅_{k,m}=((Σ*ₘ)⁻¹+Σₖ⁻¹)⁻¹

It is then possible to proceed with the sampling of Cᵢ, Xᵢ), for any i≦n on the iteration t+1.
C*ᵢ is generated independently 601 such that:

$${C}_{i}^{*} {∼}^{ind} {\sum }_{k = 1}^{{κ}^{*}} {\tilde{w}}_{k , i} {δ}_{k} ( \cdot )$$

$$with$$

$${\tilde{w}}_{k , i} ∝ ( {w}_{k} > {u}_{i} ) max ( {w}_{k} , ζ ) {\tilde{η}}_{k , Y ,} {f}_{{Q}_{{D}_{k}}^{*}} ( {T}_{i} )$$

$$and$$

$${\sum }_{k = 1}^{{κ}^{*}} {\overline{w}}_{k , i} = 1.$$

Then X*ᵢ is generated independently 602 such that:

X*ᵢ [symbol] N(X*ᵢ| m̅_{C*}_{ᵢ}_{,Y}_{ᵢ}, Σ̅_{C*}_{ᵢ}_{,Y}_{ᵢ})

The acceptance ratios ω((C*ᵢ, X*ᵢ), (Cᵢ^{(t)}, Xᵢ^{(t)})) are then computed 603:

$$\begin{matrix}ω ( ( {C}_{i}^{*} , {X}_{i}^{*} ) , ( {C}_{i}^{( t )} , {X}_{i}^{( t )} ) ) = \frac{𝒫 ( {Y}_{i} \vert {X}_{i}^{*} )}{𝒫 ( {Y}_{i} \vert {X}_{i}^{( t )} )} \cdot \frac{{f}_{𝒩} ( {X}_{i}^{( t )} \vert {m}_{{Y}_{i}}^{*} , {Σ}_{{Y}_{i}}^{*} )}{{f}_{𝒩} ( {X}_{i}^{*} \vert {m}_{{Y}_{i}}^{*} , {Σ}_{{Y}_{i}}^{*} )} \\ = ω ( {X}_{i}^{*} , {X}_{i}^{( t )} )\end{matrix}$$

It will be able to be noted that \tilde{G}ᵢ(Cᵢ, Xᵢ) and Cᵢ disappear from the acceptance ratio.

It then remains to test 604 the acceptance of (C*ᵢ, X*ᵢ), that is to say assign (Cᵢ^{(t+1)}, Xᵢ^{(t+1)})=(C*ᵢ, X*ᵢ) with the probability

min(1,ω(X*ᵢ, Xᵢ^{(t)}))

otherwise assign (Cᵢ^{(t+1)}, Xᵢ^{(t+1)})=(Cᵢ^{(t)}, Xᵢ^{(t)}))
FIG. 7 presents a way of computing the concentration λₖ. The evaluation of λₖ is necessary for the generation of (V, Γ, v|D, w, \tilde{Z}, T) and of (D|V, v, Q*, Γ, w, \tilde{Z}, C, T).
The expression of λₖ for the particular choice of φ_{λ}(\tilde{Z}ₖ, S) given previously, can be determined according to the equation (5) by using the expression:

$${λ}_{k} = {𝔼}_{{\tilde{x}}_{k}} ( {\sum }_{m = 1}^{∞} {w}_{m} 𝒩 ( {\tilde{x}}_{k} \vert {\tilde{Z}}_{m} ) )$$

This expression can be evaluated by a significant sampling technique. For this, for a given number of particles T_{λ} and for any k, the following is generated independently 700 for any l≦T_{λ}:

\tilde{x}ₖₗ [symbol] N(\tilde{x}ₖₗ|\tilde{Z}ₖ)

Then, the following is computed 701 for any l≦T_{λ}:

$${\tilde{λ}}_{kl} \approx {\sum }_{m = 1}^{{κ}^{*}} {w}_{m} 𝒩 ( {\tilde{x}}_{kl} \vert {\tilde{Z}}_{m} )$$

In a third stage 702, λₖ is evaluated:

$${λ}_{k} \approx \frac{1}{{T}_{λ}} {\sum }_{l = 1}^{{T}_{λ}} {\tilde{λ}}_{kl}$$

The functional volumes VF then remain to be determined 105.

Once the MCMC algorithm has reached balance equilibrium, the sampler provides draws of the a posteriori joint law of (X, C, D, w, u, \tilde{Z}, Q*|Y, T). For each draw of parameters retained, it is possible to construct a sample of the space-time activity distribution of the events recorded on the iteration (t):

$${f}_{G}^{( t )} ( x , t ) = {\sum }_{k = 1}^{{κ}^{*}} {w}_{k} {f}_{𝒩} ( x \vert {\tilde{Z}}_{k} ) {f}_{{\tilde{Q}}_{k}} ( t ) , \qquad ( 6 )$$

The space-time density corresponding to all the events, which are not necessarily observable, is obtained by normalization.
Similarly, the entire distribution of the functional volumes is accessible. We marginalize over time and define the spatial distribution of a functional volume j associated with the kinetic Q*ⱼ on the iteration (1) by using the expression:

$${f}_{{VF}_{j}}^{( t )} ( x ) = {\sum }_{k : {\tilde{Q}}_{k} = {Q}_{j}^{*}}^{{κ}^{*}} {w}_{k} {f}_{𝒩} ( x \vert {\tilde{Z}}_{k} ) . \qquad ( 7 )$$

All the elements are then available to determine the estimators of space-time activity distribution and functional volumes VF for T iterations of the algorithm that are retained. The following expressions can then be used for that:

$$\begin{matrix}𝔼 ( {f}_{G} ( x , t ) \vert Y , T ) \approx \frac{1}{T} {\sum }_{t = 1}^{T} {f}_{G}^{( t )} ( x , t ) \\ and & ( 8 ) \\ 𝔼 ( {f}_{{VF}_{j}} ( x ) \vert Y , T ) \approx \frac{1}{T} {\sum }_{t = 1}^{T} {f}_{{VF}_{j}}^{( t )} ( x ) & ( 9 )\end{matrix}$$

Similarly, any other functional of the a posteriori distributions can be computed, like a conditional variance or a credibility interval.

1. A method for determining functional volumes for the search for kinetics representing the trend of the concentration of a radioactive tracer in an area of biological tissue, the method being applied to spatial components and comprising the following steps applied iteratively according to a Markov chain Monte-Carlo scheme:
a step of generation of a set K₀^{λ} made up of a set of candidate kinetics associated with values of probability of appearance of these kinetics, these values depending on the concentration λ of radioactive tracer;
a labeling step during which, for each spatial component of index K, the probabilities of selection of the kinetics of the set K₀^{λ} are weighted by introducing therein a function λₖ representative of the concentration of radioactive tracer in this component so as to obtain a set of indicative values, an indicative value Dₖ designating the kinetic with which the spatial component K is associated;
a step of construction of functional volumes, a functional volume VFⱼ being made up of the set of the spatial components which share the same indicative value Dₖ.

2. The method as claimed in claim 1, further comprising a step of computation of the averages of the functional volumes VFⱼ obtained during the iterative process.

3. The method as claimed in claim 1, comprising a step of determination of statistical estimators concerning the functional volumes VFⱼ obtained during the iterative process so as to quantify the estimation uncertainty.

4. The method as claimed in claim 3, in which the variance of the functional volumes VFⱼ obtained during the iterative process is determined.

5. The method as claimed in claim 3, in which a credible interval is determined.

6. The method as claimed in claim 1, in which the set K₀^{λ} is obtained by the determination (100) of two sets of scalar variables Vⱼ and Γⱼ, these variables relating to kinetic components of index j, in which Vⱼ represents a fixed weighting coefficient independent of the concentration λ and Γⱼ represents a reference concentration value associated with the kinetic of index j.

7. The method as claimed in claim 6, in which Vⱼ is determined by using the expression:
$$a . {V}_{j} \vert D , T {∼}^{ind} Beta ( 1 + {m}_{j} , ν + {\sum }_{l = j + 1}^{{J}_{{κ}_{n}}} {m}_{l} )$$
an expression in which:
for any j, mⱼ designates the number of components of the distribution H allocated to the j^{th} component of K₀^{Λ}, H being a random measurement distributed according to a partially dependent Dirichlet process, K₀^{Λ} being an innumerable collection of random probability measurements which accepts, as distribution, a local Dirichlet process;
Jₖ_{ₙ} designates the greatest index of the components of K₀^{Λ} having at least one component of H allocated;
Beta(,) represents the beta probability law.

8. The method as claimed in claim 6, in which Γⱼ is determined using the expression:
$${Γ}_{j} \vert {V}_{j} , D , w , \tilde{Z} {∼}^{ind} {𝒰}_{j}^{*} ( {Γ}_{j} )$$
$$with$$
$${𝒰}_{j}^{*} ( {Γ}_{j} ) ∝ ( {a}_{j , Γ}^{′} < {Γ}_{j} < {b}_{j , Γ}^{′} ) \times {\prod }_{k ∈ {𝒟}_{j}^{+}} ( 1 - {V}_{j} ( d ( {λ}_{k} , {Γ}_{j} ) < ψ ) )$$
expressions in which:
Γⱼ designates the parameter characteristic of the concentration associated with the kinetic j;
D designates the set of variables Dₖ which indicate with which kinetic of K₀^{λ} the spatial component K is associated;
Dⱼ−{k≦kₙ: Dₖ−j} represents the set of the indices K of the spatial components associated with the kinetic j;
Dⱼ⁺={k≦kₙ: Dₖ>j} represents the set of the indices K of the spatial components associated with a kinetic of index greater than j;
w designates the set of the weightings wₖ of the spatial components k in the Dirichlet mixture H;
\tilde{Z} designates the set of the parameters, average and covariance matrix, \tilde{Z}ₖ associated with the spatial component K of the Dirichlet mixture H; [symbol]
here indicates an independent random generation for each parameter Γⱼ;
∝ here signifies “proportional to”; [symbol]
( ) represents the “gate” function such that [symbol] (condition)=1 if condition is true, and 0 otherwise;
Vⱼ designates a coefficient associated with each kinetic involved in the weighting of said kinetic in K₀^{λ};
d( ) represents the Euclidian distance in [symbol] : d(x₁,x₂)=|x₁−x₂| in which x₁, x₂∈ [symbol] ;
ψ is a threshold chosen a priori which makes it possible to parameterize K₀^{λ}.

9. The method as claimed in claim 1, in which the labeling step (109) is performed:
by independently generating (500) for any k≦kₙ:
$$( {D}_{k} \vert V , v , {Q}^{*} , Γ , w , \tilde{Z} , C , T ) {∼}^{ind} {\sum }_{j = 1}^{{J}^{*}} {p}_{j , k} {δ}_{j} ( \cdot )$$
$$with$$
$${p}_{j , k} ∝ ( {p}_{j} ( {λ}_{k} ) > {υ}_{k} ) max ( {p}_{j} ( {λ}_{k} ) , ς ) {\prod }_{\{ 1 : {C}_{i} - k \}} {f}_{{Q}_{i}^{*}} ( {T}_{i} ) \\ and \\ {\sum }_{j = 1}^{{J}^{*}} {p}_{j , k} = 1$$
by independently generating (501) for any K, such that kₙ<k<k*:
$$( {D}_{k} \vert V , v , Γ , w , \tilde{Z} ) {∼}^{ind} {\sum }_{j = 1}^{{J}^{*}} {p}_{j , k} {δ}_{j} ( \cdot )$$
$$with$$
$${p}_{j , k} ∝ ( {p}_{j} ( {λ}_{k} ) > {υ}_{k} ) max ( {p}_{j} ( {λ}_{k} ) , ς )$$
$$and$$
$${\sum }_{j = 1}^{{J}^{*}} {p}_{j , k} = 1.$$
in these expressions,
kₙ designates the number of spatial components with which at least one coincidence event is associated;
k* designates the total number of spatial components of the Dirichlet mixture H for a given iteration;
V designates the set of the coefficients Vⱼ involved in the weightings of the kinetics mixture K₀^{λ};
v represents the set of the auxiliary variables vₖ used in the representation of the Dirichlet kinetics process;
Q* designates the set of the Pólya trees Qⱼ* characterizing the kinetics;
Γ designates the set of the parameters Γⱼ characteristic of the concentration associated with the kinetic j;
C designates the set of the classification variables Cᵢ which associate each coincidence event i with a spatial component of the Dirichlet mixture H;
T represents the set of the times of occurrences Tᵢ of the coincidence events;
p_{j,k} designates the probability of associating the component K of the Dirichlet mixture H with the kinetic j;
pⱼ(λ) represents the weight function taken at λ associated with the probability of the kinetic j of K₀^{λ};
δⱼ( ) represents the Dirac measurement function such that δⱼ(j′)=1 if j=j′ and is 0 otherwise; [symbol]
here indicates an independent random generation for each classification variable Dₖ;
max( ) represents the “maximum of” function;
ζ designates is a threshold parameter chosen arbitrarily involved in the implementation of the slice sampling algorithm of the local Dirichlet kinetics process;
{i: Cᵢ=k} designates the set of the coincidence events i which are associated with the spatial component K;
f_{Q*}_{ⱼ} represents the kinetic j, i.e. the density of the Pólya tree j of the local Dirichlet mixture of kinetics;
J* designates the total number of components of the local Dirichlet mixture of kinetics for a given iteration.

10. The method as claimed in claim 1, in which the concentration λₖ is obtained by the application of a function φ_{λ} defined such that λₖ=φ_{λ}(\tilde{Z}ₖ, S) with:
$${λ}_{k} = {𝔼}_{{\tilde{x}}_{k}} ( {\sum }_{m = 1}^{∞} {w}_{m} 𝒩 ( {\tilde{x}}_{k} \vert {\tilde{Z}}_{m} ) ) with {\tilde{x}}_{k} ∼ 𝒩 ( {\tilde{x}}_{k} \vert {\tilde{Z}}_{k} )$$
in which: [symbol]
ₖ_{ₙ} designates the mathematical expectation relative to the Gaussian probability law of \tilde{x}ₖ, N(\tilde{x}ₖ|\tilde{Z}ₖ);
N( ) represents the Gaussian probability law.

11. A positron emission tomography device implementing the method as claimed in claim 1.
